(19) United States
(12) Patent Application Publication
(10) Pub. No.: US 2022/0339848 A1
(43) Pub. Date: Oct. 27, 2022

(54) METHOD FOR MANUFACTURING A PLASTIC CONTAINER, COMPRISING NON-REFRIGERATED COOLING OF A MOULD BASE

(71) Applicant: SIDEL PARTICIPATIONS, OCTEVILLE-SUR-MER (FR)

(72) Inventor: Mikaël DERRIEN, OCTEVILLE-SUR-MER (FR)

(21) Appl. No.: 17/642,289

(22) PCT Filed: Sep. 9, 2020
(86) PCT No.: PCT/EP2020/075218

§ 371 Date: Mar. 11, 2022

(30) Foreign Application Priority Data
Sep. 11, 2019 (FR) FR1909982

(51) Int. Cl. B29C 49/48

(52) U.S. Cl. CPC B29C 49/4823; B29C 2049/483; B29C 2049/4838; B29L 2031/7158

(57) ABSTRACT

The invention relates to a method for manufacturing containers by blow-molding or stretch-blow-molding from plastic preforms, the method comprising a step of cooling a mold bottom by circulation of a heat transfer fluid inside a cavity of the mold bottom, the step of cooling a mold bottom being carried out with a non-refrigerated heat transfer fluid at a temperature lower than or equal to 30° C.

The field of the invention is that of the design and manufacture of plastic containers from preforms.

More specifically, the invention relates to a manufacturing method and machine for producing plastic containers, having a step of cooling a mold bottom in which step a heat transfer stream is injected into a cavity of the mold bottom.

Conventionally, a preform comprises a hollow body, which is generally a cylinder of revolution, a neck that constitutes the mouth of the container to be formed, and a bottom that closes the body at the end opposite the neck. The bottom is usually hemispherical or at the very least exhibits symmetry of revolution about the longitudinal axis of the preform.

In order to produce a preform, an injection mold is used that has an injection core (which determines the shape of the inside of the preform) and an outer wall (which determines the outside of the preform). The internal volume determined by the arrangement of the core and of the outer wall determines the final shape of the preform. The constituent plastic material of the preform is injected at a very high temperature (the material is fluid) and a high pressure into the injection mold via a duct that opens into this volume, though the outer wall, at a location of the wall that is centered on the bottom of the preform.

The conventional technique for manufacturing a container from a preform consists in introducing the preform, which has been heated beforehand, inside a heating unit, to a temperature higher than the glass transition temperature of the material (approximately 80 degrees Celsius in the case of PET), into a mold provided with a wall that defines a cavity with the imprint of the container, and in injecting, into the preform, via a nozzle, a fluid such as a gas (generally air) under pressure so as to press the material of the preform against the wall of the mold.

The mold can be constituted of two half-shells and a mold bottom.

As the containers are being manufactured, this mold bottom experiences an increase in temperature.

The increase in the temperature of the mold bottom can cause malformations of the bottoms of the formed containers. Cooling of the mold bottoms is then carried out so as to control their temperature and the shape of the containers obtained. Specifically, in the absence of cooling of the mold bottom, the bottoms of the formed containers would sag.

To this end, the mold bottoms are provided with a cavity, or more specifically channels (which are denoted below by the expression “a cavity”), in which, during a step of cooling the bottom of the mold, a heat transfer fluid is circulated.

In practice, there is a tendency to cool the mold bottoms as much as possible so that the bottoms of the containers are also cooled as much as possible.

The container forming units thus comprise a cooler designed to refrigerate the heat transfer fluid that is intended to circulate in the cavity of the mold bottom.

The heat transfer stream is thus refrigerated to a temperature of approximately 12° C. by the cooler, before being sent into the cavity of the mold bottom via a feed duct that opens into the cavity.

Such cooling of the mold bottom makes it possible to obtain a bottle that has the desired characteristics and is suitable for marketing.

However, the use of a cooler causes an energy consumption that is not insignificant.

In particular, the aim of the invention is to remedy the drawbacks of the prior art.

More specifically, the aim of the invention is to propose a manufacturing method and a manufacturing machine that make it possible to obtain a marketable container, while at the same time reducing the energy consumption necessary for the manufacture of the container compared with the energy consumed during the manufacture of containers with a manufacturing method and machine according to the prior art.

Another aim of the invention is to provide such a method that makes it possible to simplify the manufacturing method and the manufacturing machine with respect to those according to the prior art.

These aims, along with others that will become apparent below, are achieved by virtue of the invention, the subject of which is a method for manufacturing containers by blow-molding or stretch-blow-molding from plastic preforms, the method comprising a step of cooling a mold bottom by circulation of a heat transfer fluid inside a cavity of the mold bottom, wherein the step of cooling a mold bottom is carried out with a non-refrigerated heat transfer fluid at a temperature lower than or equal to 30° C.

Contrary to the technical prejudice of the prior art according to which it is absolutely necessary to cool the bottoms of the containers formed in the molds as much as possible, it has been discovered that the heat transfer fluid used in the step of cooling the mold bottom could be non-refrigerated, while at the same time having a temperature lower than or equal to 30° C.

As a result, it is not necessary to use a cooler to refrigerate the heat transfer fluid used during the step of cooling the mold bottom.

For example, a heat transfer fluid at ambient temperature, which is of course lower than or equal to 30° C., can be used directly in the cooling step, and this avoids the energy consumption induced by the operation of the cooler.

Such a non-refrigerated heat transfer fluid at a temperature lower than or equal to 30° C. also makes it possible to obtain a container having good characteristics or, in other words, not having malformations that are incompatible with the use and marketing of said container.

In addition, it has been noted, surprisingly, that containers obtained using the manufacturing method according to the invention have a good geometry of the bottom of the container since the thermal differences obtained on the periphery thereof can contribute, via the shrinkage effect, to generating a lever effect toward the inside of the bottom of the container. This implies a limiting of the effect of the sagging of the bottom of the bottle as it leaves a container forming unit in which the preforms are blow-molded.

This effect makes it possible to increase the number of containers that are considered to meet the expected quality criteria compared with those obtained in a container manufacturing method according to the prior art.

It is noted that beyond 30 degrees Celsius a lack of cooling of the bottoms of the containers, and therefore sagging of the bottom of these containers, occurs.

Preferentially, the step of cooling a mold bottom is carried out with a heat transfer fluid at a temperature lower than or equal to 25° C.

Up to 25° C. an optimum transfer of the heat energy during the cooling of the mold bottoms has been observed.

Advantageously, the step of cooling a mold bottom is carried out with a heat transfer fluid at a temperature higher than or equal to 18° C.

Around 18° C., the heat transfer fluid can simply be water from a conventional water distribution network.

More effectively, the step of cooling a mold bottom is carried out with a heat transfer fluid at a temperature higher than or equal to 21° C.

Such a temperature of the heat transfer fluid allows good cooling of the mold bottoms while at the same time corresponding to an observed average temperature of water taken from a conventional water distribution network, after its transfer into the piping of a plastic container manufacturing machine.

According to a preferred embodiment, the step of cooling a mold bottom is carried out with a heat transfer fluid at a temperature equal to 25° C.

Such a heat transfer fluid temperature then optimizes the relationship between the cooling of the mold bottoms, the energy used by the method and the final shape of the containers obtained.

Advantageously, the heat transfer fluid is also used for a step of cooling means for protecting necks of the preforms in a heating unit that is situated upstream of the part of the machine comprising the one or more molds.

In this way, the same heat transfer fluid is used for the step of cooling the protection means and the step of cooling the mold bottoms. The use of a temperature of at least 21° C. for the heat transfer fluid for the cooling of the means for protecting the necks of the preforms is important in order to prevent the appearance of condensation in the heating unit.

According to the prior art, the heat transfer fluid used to cool the means for protecting the necks of the preforms of the heating unit is heated to 25° C. As a result, the non-refrigerated heat transfer fluid is advantageously also used without it having to be heated as in the prior art.

Advantageously, the heat transfer fluid is also used for a step of cooling shells of the mold, i.e. the parts of the mold that serve to form the bodies and shoulders of the containers.

The cooling of the mold is thus also carried out with a non-refrigerated heat transfer fluid, avoiding recourse to a cooler.

Another subject of the invention is a machine for manufacturing containers, by blow-molding or stretch-blow-molding from plastic preforms, the manufacturing machine comprising:
a mold having a mold bottom in which a cavity is provided;
a heat transfer fluid feed duct that opens into the cavity;
a duct for the exit of the heat transfer fluid from the cavity;

wherein it comprises means for supplying the feed duct with a non-refrigerated heat transfer fluid at a temperature lower than or equal to 30 degrees Celsius.

The manufacturing machine according to the invention implements the above-described method according to the invention.

Thus, the features of the method and the related advantages can also be applied to the manufacturing machine according to the invention.

Other features and advantages of the invention will become more clearly apparent on reading the following description of a preferential embodiment of the invention, which is given by way of illustrative and nonlimiting example, and the appended drawings in which:

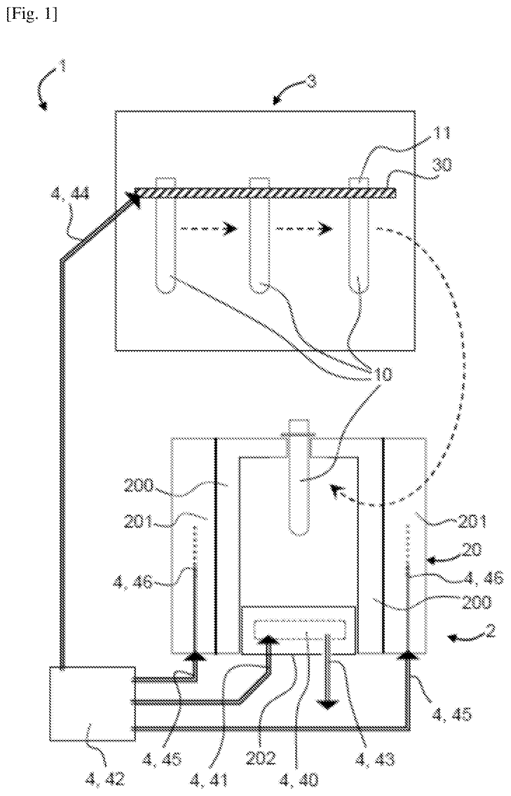

FIG. 1 is a schematic depiction illustrating a machine for manufacturing containers that implements a manufacturing method according to the invention;

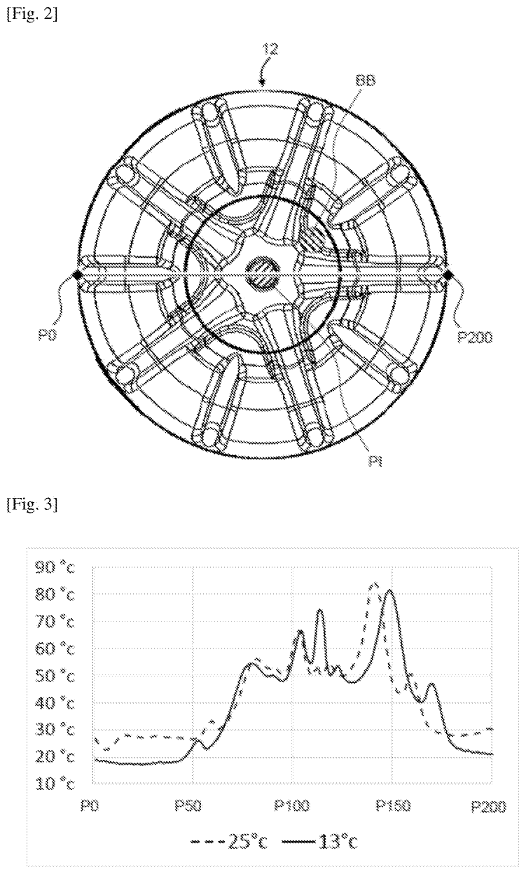

FIG. 2 is a schematic illustration, from above, of the bottom of a formed container;

FIG. 3 is a curve illustrating the differences in temperatures read at the bottom of a container according to a method according to the invention and a method according to the prior art, with two different heat transfer fluid temperatures.

With reference to FIG. 1 and according to the principle of the invention, a machine 1 for manufacturing containers by blow-molding or stretch-blow-molding from preforms 10 is illustrated. This manufacturing machine 1 implements the method according to the invention, which makes it possible to manufacture containers by blow-molding or stretch-blow-molding from plastic preforms 10.

This manufacturing machine 1 comprises a unit 3 for heating the preforms 10 and a forming unit 2.

For the manufacture of containers by blow-molding or stretch-blow-molding, the preforms 10 are heated in the heating unit 3 and then each disposed in a mold 20 of the forming unit 2 where they are blow-molded or stretched and blow-molded.

According to the present embodiment, the mold 20 comprises:
two shells 200 that, when put together, form the imprint of the body of a container;
two shell 200 supports 201;
a mold 20 bottom 202, which has the imprint of the bottom of a container.

Since the preforms 10 are heated, the mold 20 bottoms 202 have a tendency to heat up when the bottom of the formed containers comes into contact therewith during the manufacture of the containers.

The manufacturing machine 1 then comprises a cooling system 4 intended to cool, inter alia, the mold 20 bottoms 202.

The mold 20 bottoms 202 comprise a cavity 40 intended to receive a heat transfer fluid so as to cool them.

The manufacturing machine 1, and more specifically the cooling system 4, comprises:
a feed duct 41 that opens into the cavity 40 so as to provide the heat transfer fluid to the mold 20 bottom 202;
an exit duct 43 from the cavity 40;
means 42 for supplying the feed duct 41 with the heat transfer fluid.

The expression “cavity” denotes any type of cavity or circuit such as channels provided in the mold 20 bottoms 202 and intended to allow cooling thereof.

The manufacturing method consequently comprises a step of cooling the mold 20 bottom 202 by virtue of the circulation of the heat transfer fluid inside the cavity 40 of the mold 20 bottom 202.

According to the principle of the invention, this step of cooling the mold bottom 202 is carried out with a heat transfer fluid that is non-refrigerated and has a temperature lower than or equal to 30° C.

By virtue of this feature of the heat transfer fluid, the manufacturing method according to the invention does not require a prior step of refrigerating the heat transfer fluid.

As a result, the manufacturing machine 1 according to the invention does not comprise a cooler intended to cool the heat transfer fluid or dedicated to cooling the heat transfer fluid.

Tests have made it possible to observe that a non-refrigerated heat transfer fluid at a temperature lower than or equal to 30° C. makes it possible to obtain adequate cooling of the mold 20 bottom 202.

Specifically, the more the rate of production of the containers (which can reach rates much higher than 2500 bottles/mold/hour) and the blow-molding pressure decrease, then the more the time for which the material constituting the container (for example PET) is in contact with the bottom of the mold decreases, and consequently the more the temperature of the periphery of the bottom of the container tends to increase.

This is due to the fact that this periphery of the bottom of the container is the last part of the container to be formed during the process of blow-molding the container in the mold 20 and that it corresponds to the part of the bottom of the container that is in contact with the mold bottom for the shortest time.

This shows, in view of the temperatures reached at this periphery of the bottom of the containers, that cooling the mold bottom to 10° C. is not absolutely necessary under these production conditions, since the material constituting the container does not have time to reach the temperature for regulation of the mold bottom.

It should also be noted that, the more the rate of manufacture of containers is increased, the less the effect of the difference in temperature of the heat transfer fluid used to cool the mold bottom is visible on the formed containers.

Beyond 30° C., a lack of cooling of the bottoms of the formed containers, which can then sometimes exhibit sagging of their arch, has however been observed.

Advantageously, the temperature of the heat transfer fluid is higher than or equal to 18° C., and more advantageously higher than or equal to 21° C. In this way, the heat transfer fluid can come directly from a water distribution network of the location where the manufacturing machine 1 is installed.

Preferentially, the heat transfer fluid is at a temperature that is lower than or equal to 25° C., and even more preferentially equal to 25° C.

TABLE 1

| Production rate | Temperature | Flow rate | Depth of the bottom (in millimeters) | | | | | |
|---|---|---|---|---|---|---|---|---|
| (in bottles | of the heat | of the heat | At the junction (BB) | | | At the point of | | |
| per hour | transfer | transfer | of the branches | | | injection (PI) | | |
| per mold) | fluid | fluid | min | average | max | min | average | max |
| 2500 | 13° C. | 0.7 m³ · h⁻¹ | 3.9 | 4.0 | 4.1 | 8.2 | 8.3 | 8.4 |
| | | 0.2 m³ · h⁻¹ | 3.9 | 4.0 | 4.2 | 7.7 | 8.0 | 8.1 |
| | 25° C. | 0.7 m³ · h⁻¹ | 3.9 | 4.0 | 4.3 | 7.4 | 7.7 | 8.0 |
| | | 0.2 m³ · h⁻¹ | 3.9 | 4.0 | 4.2 | 7.4 | 7.8 | 8.2 |
| 2700 | 35° C. | 0.2 m³ · h⁻¹ | 3.9 | 4.2 | 4.3 | 6.1 | 6.4 | 6.9 |

The table above illustrates, for a container with a capacity of 50 centiliters, differences in depths of bottoms 12 of containers produced using the installation and method according to the invention, for production at 2500 and 2700 bottles per hour per mold, and with a heat transfer fluid at 13° C., 25° C. and 35° C. circulating at two different flow rates in the cavities of the mold bottoms 202.

FIG. 2 illustrates a container bottom 12 on which both the location of a junction BB between two successive branches of a container bottom 12, and the point of injection PI that is situated at the center of the container bottom 12, are shown using hatched circles.

These results make it possible to determine that at 25° C. the measured container bottom 12 depths are more or less the same as at 10° C. The bottles produced with a heat transfer fluid at 25° C. are therefore considered to be good.

These results also make it possible to demonstrate that at 35° C. the depths measured at the center of the bottom, at the point of injection PI, are less than those measured at 13° C. and 25° C., but that the depths at the junction BB of two branches are greater, thus showing the lever effect that, with a small peripheral shrinkage, makes it possible to increase the clearance (i.e. the measurement of the depth of the bottom of the container) at this point.

However, beyond 30° C. a negative effect can be observed on the very wall of the body of the container, which wall is situated above the bottom of the container, since this part is in contact with the mold bottom for a longer time. This negative effect corresponds to an undesirable deformation of the wall of the body of the container.

In FIG. 2, a transverse profile of the bottom 12 of the formed container is identified, along the plane P0-P200.

The curves in FIG. 3 correspond to temperature readings on the transverse profile. These temperatures are read on containers as they leave the forming unit 2.

These readings are obtained on one and the same machine, for one and the same production rate, for the same type of container. The curve with a refrigerated heat transfer fluid at 13° C. corresponds to the method according to the prior art, and the curve with a non-refrigerated heat transfer fluid at 25° C. corresponds to the method according to the invention.

The analysis of these curves demonstrates that the most notable differences in temperature are situated toward the peripheral part of the bottom 12 of the container (zones P0-P50 and P150-P200).

It should be noted that the material constituting the container, PET, is a good thermal insulator.

Therefore, the center of the container, on either side of the zone P100, which is thicker, continues to heat the rest of the bottom 12 of the container by diffusion of the temperature at the end of the step of blow-molding of the container in the mold. This transfer of heat energy is carried out from the inside of the container, while it is the outer skin of the container that is cooled. In other words, the outer skin of the container heats up under the effect of this transfer of heat energy.

A difference of 2° C. to 7° C. on the outside of the container ultimately has only a small impact on the final container, since the outer skin tends to heat up naturally. This heating occurs very rapidly since this zone is normally stretched, and therefore of small thickness, and since the temperature in this zone is very much lower than the glass transition temperature.

In conclusion, the decrease in the cooling between a method for cooling the mold 20 bottom 202 with a refrigerated heat transfer fluid, according to the prior art, and with a non-refrigerated heat transfer fluid, at 25° C., has only limited consequences, in particular for the high production rates.

According to the present embodiment illustrated in FIG. 1, the shells 200 of the mold 20 and the means 30 for protecting the necks 11 of the preforms 10 are also cooled.

In order to cool the shells 200, the cooling system 4 comprises pipes 46 provided in the shell 200 supports 201.

The means 42 for supplying heat transfer fluid are coupled to the pipes 46 via first means 45 for channeling the heat transfer fluid.

The heat transfer fluid circulating in the shell 200 supports 201 then allows the cooling of the shells 200 by transfer of the heat energy from the shells 200 to the supports 201 and then to the heat transfer fluid.

In the heating unit 3, the aim of the protection means 30 is to prevent the necks 11 of the preforms 10 overheating when the body of the preforms is heated.

These protection means usually take the form of two mutually parallel protective shields.

The means 42 for supplying heat transfer fluid are thus also coupled to the means 30 for protecting the necks 11 via second means 44 for channeling the heat transfer fluid.

The preferred temperature of the heat transfer fluid of 25° C. then proves particularly suitable.

Specifically, in view of the temperatures of the heating units, the use of a refrigerated heat transfer fluid to cool the protective shields would cause condensation to appear in the heating unit, and this is particularly undesirable.

Consequently, the use of a heat transfer fluid at 25° C., and at least at a temperature higher than or equal to 21° C. makes it possible to prevent or limit the appearance of condensation.

At 25° C., the heat transfer fluid can thus be used to cool the molds 20 (including the mold bottoms 202, and indirectly the shells 200) of the forming unit 2, and the means 30 for protecting the necks 11 of the preforms 10 in the heating unit 3.

1. A method for manufacturing containers by blow-molding or stretch-blow-molding from plastic preforms (10), the method comprising a step of cooling a mold (20) bottom (202) by circulation of a heat transfer fluid inside a cavity (40) of the mold (20) bottom (202), wherein the step of cooling a mold (20) bottom (202) is carried out with a non-refrigerated heat transfer fluid at a temperature lower than or equal to 30° C.

2. The method as claimed in claim 1, wherein the step of cooling a mold (20) bottom (202) is carried out with a heat transfer fluid at a temperature lower than or equal to 25° C.

3. The method as claimed in claim 1, wherein the step of cooling a mold (20) bottom (202) is carried out with a heat transfer fluid at a temperature higher than or equal to 18° C.

4. The method as claimed in claim 3, wherein the step of cooling a mold (20) bottom (202) is carried out with a heat transfer fluid at a temperature higher than or equal to 21° C.

5. The method as claimed in claim 1, wherein the step of cooling a mold (20) bottom (202) is carried out with a heat transfer fluid at a temperature equal to 25° C.

6. The method as claimed in claim 4, wherein the heat transfer fluid is also used for a step of cooling means (30) for protecting the necks (11) of the preforms (10) in a heating unit (3).

7. The method as claimed in claim 1, wherein the heat transfer fluid is also used for a step of cooling shells (200) of the mold (20).

8. A machine (1) for manufacturing containers by blow-molding or stretch-blow-molding from plastic preforms (10), the manufacturing machine (1) comprising:
a mold (20) having a mold (20) bottom (202) in which a cavity (40) is provided;
a feed duct (41) that opens into the cavity (40);
an exit duct (43) from the cavity (40);
means (42) for supplying the feed duct (41) with a heat transfer fluid,
wherein it implements the method as claimed in claim 1.

9. The method as claimed in claim 2, wherein the step of cooling a mold (20) bottom (202) is carried out with a heat transfer fluid at a temperature higher than or equal to 18° C.

10. The method as claimed in claim 5, wherein the heat transfer fluid is also used for a step of cooling means (30) for protecting the necks (11) of the preforms (10) in a heating unit (3).

11. The method as claimed in claim 2, wherein the heat transfer fluid is also used for a step of cooling shells (200) of the mold (20).

12. The method as claimed in claim 3, wherein the heat transfer fluid is also used for a step of cooling shells (200) of the mold (20).

13. The method as claimed in claim 4, wherein the heat transfer fluid is also used for a step of cooling shells (200) of the mold (20).

14. The method as claimed in claim 5, wherein the heat transfer fluid is also used for a step of cooling shells (200) of the mold (20).

15. The method as claimed in claim 6, wherein the heat transfer fluid is also used for a step of cooling shells (200) of the mold (20).
